(19) United States
(12) Patent Application Publication
(10) Pub. No.: US 2016/0000057 A1
(43) Pub. Date: Jan. 7, 2016

(54) Steve's spinners

(71) Applicant: Steve Mistilis, Memphis, TN (US)

(72) Inventor: Steve Mistilis, Memphis, TN (US)

(21) Appl. No.: 14/120,853

(22) Filed: Jul. 2, 2014

(51) Int. Cl. A01K 85/10; A01K 85/01

(52) U.S. Cl. CPC A01K 85/10; A01K 85/01

(57) ABSTRACT

The current invention lure provides a body having a shape commensurate/resembling lures known as baitfish, crankbaits, jerkbaits, surface plugs, floating/diving plugs, and poppers and other creatures and shapes known to attract fish. The current invention also provides novel means to attract fish with spinners, beads, cones, and other geometric shapes, drums, cages and ribbons which may be interchanged by the user from a kit of these elements. Flexible ribbons may also serve as carriers of sent eluding liquids or pastes. Each spinner may include vanes or impellers to impart rotation by the relative motion of the water as the lure is pulled through the water.

### CROSS-REFERENCE TO RELATED APPLICATIONS

Not Applicable

### BACKGROUND OF THE INVENTION

The current invention relates to fishing lures substantially, if not exclusively, within class CCL 43.

Fishing lures aka artificial bait have been known and practiced for several hundred years. Originally, or by legend, a person carved a fish shape from wood while near a pond and when leaving tossed the object into the water and noticed a fish immediately struck, attempted to eat, the object as if it were a bait fish. Lures are based on the fact that predatory fish eat “baitfish” and the larger the predator the larger the maximum size or even preferred baitfish will be sought. Reusability and storage of a “decoy” versus mortality of bait fish, ability to enhance attractiveness and the personalization of lures promoted an industry. Lures also present the ability to put multiple hooks and multi hooks often a cluster of three hooks known as treble hooks on the lure versus a single end of line hook.

Baitfish is only one category of prey sought by predatory fish. Fishing lures have several common generalized appearances and functions. Lures are made to resemble baitfish, insects, frogs and other prey and each may have active features. Active features may include, but not limited to: Buoyancy; moving features energized by pulling the lure through the water; direction of lure movement also utilizing being pulled through the water; noise makers and even scent eluding features.

Adding spinners to lures has been practiced for a long time. These objects normally rotate on their mounting powered by their impeller shape causing rotation as the lure is pulled through water. Spoons are similar to spinners in that they rotate but they are often one sided and used conjunction with only a hook and the hook may have a skirt made of hair or similar synthetic material.

### COMPARISON AND CONTRAST TO PRIOR ART

U.S. Pat. No. 167,784 issued to Pierce Sep. 14, 1875 disclosed “Spoon-Hook for Fishing.” At two blade impeller is shaft mounted with a trailing treble hook.

U.S. Pat. No. 418,200 issued to Loftie Dec. 31, 1889 discloses “gang spoon bait.” One embodiment is notable in which the spinners are sized smaller in the front to larger and then smaller again so that the overall profile is of a minnow as the individual impellers rotate. However, Loftie does not teach exchangeability of the impellers or shaft retaining of any other features nor having a body.

U.S. Pat. No. 869,565 issued to Haverly Oct. 29, 1907 discloses a shape, frog or fish shown, that can spin on a shaft with a trailing hook in a skirt.

U.S. Pat. No. 1,627,512 issued to Hughes May 3, 1925 discloses “Artificial Bait.” It teaches a fish like body having a forward mounted impeller driving a shaft which in turn causes a rear fin shape to oscillate. Its body also including mounts for multiple treble hooks.

U.S. Pat. No. 2,516,434 issued to Swan Jul. 7, 1947 discloses a “Spinner.” This invention provides a leading spoon on a shaft followed by beads and a rear impeller spinner and a trailing treble hook. However, exchangeability of the beads or other features is not provided.

U.S. Pat. No. 2,608,016 issued to Shipley Aug. 26, 1952 discloses an “Adjustable Depth Vane Fish Lure.” This invention teaches a lure fish body with a movable diving bill spring mounted to vary the bill angle to vary the diving effect and has multi body hook mounting with treble hooks.

U.S. Pat. No. 2,783,578 issued to Moore Mar. 31, 1954 discloses a “Fishing Lure.” This invention teaches a lure having a solid forward body section, an intermediate vane spinner with bead bearings and a trailing treble hook. The forward body section appears to be shaped to also act as a diving bill. U.S. Pat. No. 2,940,205 issued to Cherry Jun. 14, 1955 discloses a “Fishing Lure.” This invention teaches several elements of Moore and adds at least a pivotally mounted after-body, a forward section bill and rear mounted treble hook. Again neither Moore nor Cherry teaches exchangeability of the spinner, multi spinners or other shaft mounted features.

U.S. Pat. No. 3,705,465 issued to Charney Dec. 12, 1972 discloses a “Fishing Lure.” Charney teaches a translucent tube body which may centrally carry a knocker ball, spinners or salmon eggs. Although this invention does teach utilizing multiple spinners inside the body it does not appear to teach user interchangeability of the spinners or changing from scent bait to knocker balls to spinners and specifically does not teach mixing of spinners, drums or cages as will be taught by this application.

U.S. Pat. No. 5,918,405 issued to Marusak Jul. 6, 1999 discloses a “Modular Fishing Lure.” Marusak chiefly consists of a central frame with replaceable soft side bodies to create different bait appearance. U.S. Pat. No. 8,490,319 issued to Mancini Jul. 23, 2013 discloses a “Fishing Lure System and Kit Having Replaceable Features and Construction.” Mancini teaches a body having many replaceable features in a kit form. However neither teaches exchangeable spinners, drums or cages.

### BRIEF SUMMARY OF THE INVENTION

The current invention lure provides a body having a shape commensurate/resembling lures known as baitfish, crankbaits, jerkbaits, surface plugs, floating/diving plugs, and poppers and other creatures and shapes known to attract fish. Game fish which may have little human food value are also sought by sportsman and may often involve larger lures. The lure may also include elements commonly known in the art including, but not limited to, diving bills, spoons and skirts on the hooks. The lure will also provide a means to remove-ably attach it to a fishing line or leader line. And further means to remove-ably attach hooks to various parts of the lure. Both of these means are common to the art and are most often a wire loop secured against being pulled open or out of the lure and often a swivel means is connected between the fishing line or hook and the attaching means or the attaching means may itself provide swivel mechanisms.

The current invention also provides novel means to attract fish with spinners, beads, cones, and other geometric shapes, drums, cages and ribbons which may be interchanged by the user from a kit of these elements. Flexible ribbons may also serve as carriers of sent eluding liquids or pastes. All shaft mounted elements collectively known as spinners. Any of the spinners may be mounted as a group on a spinner tube which will be mounted on the spinner shaft and especially ribbons. The beads may be fluted, grooved to catch the relative water movement causing rotation or impeller tabs. Spacers will also be provided to separate these items when desired and provide a bearing for spinners to act against and bearing beads whose main purpose is to act as a bearing may be included. Spacers may also be resilient to provide pressure to retain barrel type retainers. A removable shaft retaining system also accommodates personalization of the lure by combinations from the kit and may including adding unique personalized spinners.

Spinners are well known in the art as having an impeller action which causes the spinner to rotate as the body they are attached to is pulled through water. Colored beads are known in the art. Drum, for this invention, is generally defined as a cylinder having an axial exterior surface on which variation of color and reflectivity is applied. The outer axial surface may be flat, curved, faceted, repetitive or irregular geometric forms. The drum may also include tabs or fins which act as impellers to cause the drum to rotate. The drum may also have a water proof lid to allow installation of rattler beads and other objects including weights. The drum may also be specifically designed to allow entry of water to render it substantially buoyancy neutral. The cage also having a generally cylinder shape is intended to contain scent eluding material or inorganic media in a flow through mesh with loading access and in larger versions could hold live bait. The cage is loaded via a cover and has a central internal rotation tube so that it may be placed over the shaft without snagging or damaging its contents. Each of these may be individually mixed on the shaft or a premade set or partial set mounted on a tube/shaft mount of various combinations may be provided. The lure may be sold with a kit of these items and individual or groups of these sold as additional kits. The spinners, beads, drums and cages may be made of metal, synthetic or natural organic materials.

The lure body of this invention further defines an elongated longitudinal spinner aperture where the axial spinner shaft is mounted. The user will select spinners, drums or cages and load them on the shaft and then install the assembly in the aperture using shaft retaining means on each end. Both ends of the aperture may include an attaching means for the shaft or one end define a cylindrical aperture slightly larger than the shaft to receive the shaft and the opposite end companionate to a retainer. The Retaining means may be made of an elastic material attached to the lure or molded in. The user presses the shaft in and out sideways to the aperture. The retainer may also be a spring clip that would substantially surround the shaft and engage a companionate cavity at an end of the spinner aperture or a barrel with lip urged by a resilient member into a companionate aperture or cavity.

An alternative embodiment will be produced by creating the spinner aperture near a fin location of bait fish represented by the artificial bait and attaching a fin mount channel proximal to the forward part of the aperture. The fin mount will also provide attaching point apertures upper and lower for a spinner disk shaft. The fin mount is a channel shape with a closed forward portion which substantially blocks water flow to the forward part of a spinner disk therefore the relative motion of the water acting on the exposed spinner disk edge mounted vanes will spin the disk.

In applications where substantial pull is expected from the fish the lure may be made over a framework of higher tensile strength than the body. The frame having connecting attach points for the leader, hook and any other high stress points. Many fresh water fish provide a “fight” and especially salt water fish. Some game fish having lesser human food value are purely sought for their fight.

The body will be provided with a colored exterior. The coloration may be selected to give the appearance of a specific bait fish. The body may also be coated with natural and/or non-natural coloration including special effects of reflective or refractive material including special effect paints as known in the automotive finish arts. Further the body and or spinners, especially drums, may include electrically controlled reflective or refractive or light emitting media. Also electronically controlled energy emitting devices including sound and electromagnetic may be added to the body or on the spinner shaft or locked in with shaft retaining means. Each of these would further include a controller, power source, and programming/charging ports.

### BRIEF DESCRIPTION OF THE SEVERAL VIEWS OF THE DRAWING

FIG. 1 shows a side view of an artificial bait having a exchangeable spinners and spinner shaft.

FIG. 2 shows a side view of an artificial bait having a exchangeable spinners and spinner shaft.

FIG. 3 shows a side view of a spinner shaft loaded with impellers and beads.

FIG. 4 shows a side view of a spinner shaft loaded with bearing bead, cones and spacers.

FIG. 5 shows a side view of a spinner shaft loaded with bearing beads, fluted beads, spacers and beads.

FIG. 6 shows a side view of a spinner shaft loaded with bearing beads and a flag tube.

FIG. 7 shows a side view of a fluted bead.

FIG. 8 shows a side view of a fluted cone.

FIG. 9 shows a side view of a drum with impellers.

FIG. 10 shows an end view of a drum with impellers.

FIG. 11 shows a side view of a basket.

FIG. 12 shows an end view of a basket lid.

FIG. 13 shows a side view of a basket lid.

FIG. 14 shows an end view of a spinner shaft clip.

FIG. 15 shows a side view of a spinner shaft clip.

FIG. 16 shows a side view of a spinner shaft retainer barrel.

FIG. 17 shows an end view of a spinner shaft retainer barrel.

FIG. 18 shows an end view of a spinner shaft retainer pillow block.

FIG. 19 shows a side view of a spinner shaft retainer pillow block and half pillow block.

FIG. 20 shows an end view of a spinner shaft retainer half pillow block.

FIG. 21 shows a side view of an artificial bait having a spinner disk.

FIG. 22 shows a side view of a spinner disk shaft.

FIG. 23 shows a top view of a spinner disk.

### DETAILED DESCRIPTION OF THE INVENTION

Referring to FIG. 1, a side view is shown of An artificial bait comprising a lure body 1, a plurality of interchangeable spinners 7, a spinner shaft 6, companionate spinner shaft retaining means 8 and 9, said body having a forward 2, middle 3, rear section 4, diving bill 12, a spinner and drum receiving longitudinal aperture 5, each end of said aperture defining a companionate shaft retaining receiving means, and said forward section having leader attaching means 10, said body having hook(s) attaching means 11 and said rear section having a trailing hook attaching means 11, intermediate hook attaching means 13 and hooks 14.

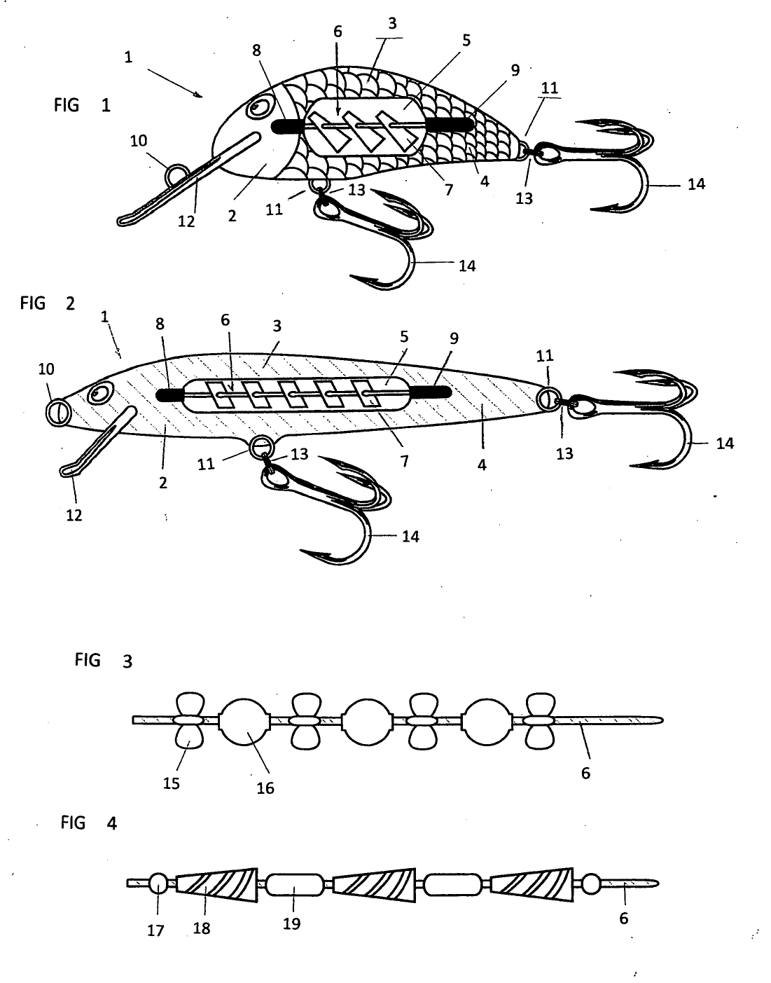

Referring to FIG. 2, a side view is shown of An artificial bait comprising a lure body 1, a plurality of interchangeable spinners 7, a spinner/drum spinner shaft 6, companionate spinner shaft retaining means 8 and 9, said body having a forward 2, middle 3, rear section 4, diving bill 12, a spinner and drum receiving longitudinal aperture 5, each end of said aperture defining a companionate shaft retaining receiving means, and said forward section having leader attaching means 10, said body having hook(s) attaching means 11 and said rear section having a trailing hook attaching means 11, intermediate hook attaching means 13 and hooks 14.

Referring to FIG. 3, a side view of a spinner shaft loaded with impellers and beads. Spinner shaft 6 has impellers 15 and beads 16 slide-ably on it.

Referring to FIG. 4, a side view of a spinner shaft loaded with bearing bead, cones and spacers. Bearing beads 17, cones 18 and spacers 19 are mounted on spinner shaft 6. Cones 18 may be solid in color or have a pattern coating and have groves 25 (FIG. 8) creating rotation by relative water flow as the artificial bait is pulled through the water.

Referring to FIG. 5 a side view of a spinner shaft loaded with bearing beads, fluted beads, spacers and beads. Bearing beads 17, fluted bead 20 which may be solid in color or have a pattern coating and spacer 19 and beads 21 are mounted on spinner shaft 6.

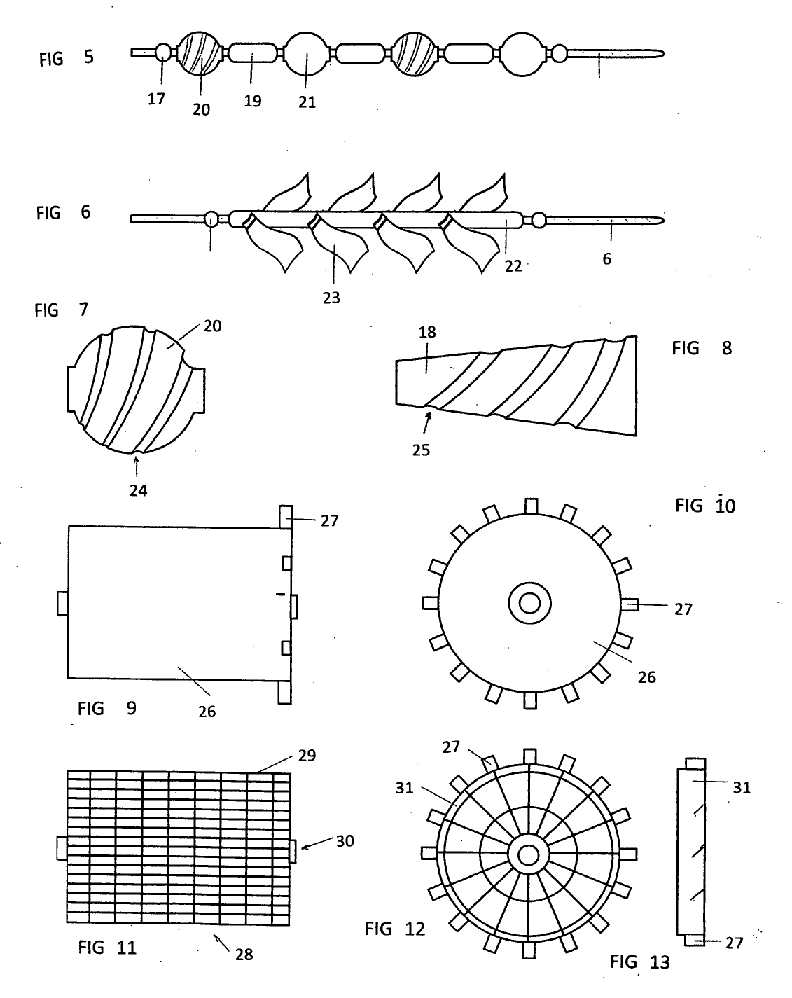

Referring to FIG. 6 shows a side view of a spinner shaft loaded with bearing beads and a flag tube 22. Bearing beads 17 are mounted on the ends of spinner shaft 6. Fluted bead 20 having groves 24 (FIG. 7) creating rotation by relative water flow and spacers 19 and beads 21 are also mounted.

Referring to FIG. 7 shows a side view of a fluted bead 20. In order to create rotation by relative water flow slanted axial groves 24 are formed in bead 20 and may be solid in color or have a pattern coating.

Referring to FIG. 8 shows a side view of a fluted cone. In order to create rotation by relative water flow slanted axial groves 25 are formed in cone 18 and may be solid in color or have a pattern coating.

Referring to FIG. 9 shows a side view of a drum with impellers. Drum 26 is cylindrical in shape and may be made to exclude or receive water and may be solid or have a pattern coating. Drum impellers 27 provide rotation by relative water flow and depending on length the drum may be put on the shaft with a mixture of other spinner attachments.

Referring to FIG. 10 shows an end view of a drum with impellers. Drum 26 is cylindrical in shape and may be made to exclude or receive water and may be solid or have a pattern coating. Drum impellers 27 provide rotation by relative water flow and depending on length the drum may be put on the shaft with a mixture of other spinner attachments.

Referring to FIG. 11 shows a side view of a basket. Basket 28 is made of mesh 29 or other flow through design to allow water to pass through it. Internal rotation tube 30 protects the contents while passing spinner shaft 6 through it. Basket 28 may be loaded with chum, blood bait, other sent material or even live bait.

Referring to FIG. 12 shows an end view of a basket lid. Basket lid 31 is also mesh 29 or other flow through material and removes from Basket 28 to facilitate loading.

Referring to FIG. 13 shows a side view of a basket lid 31.

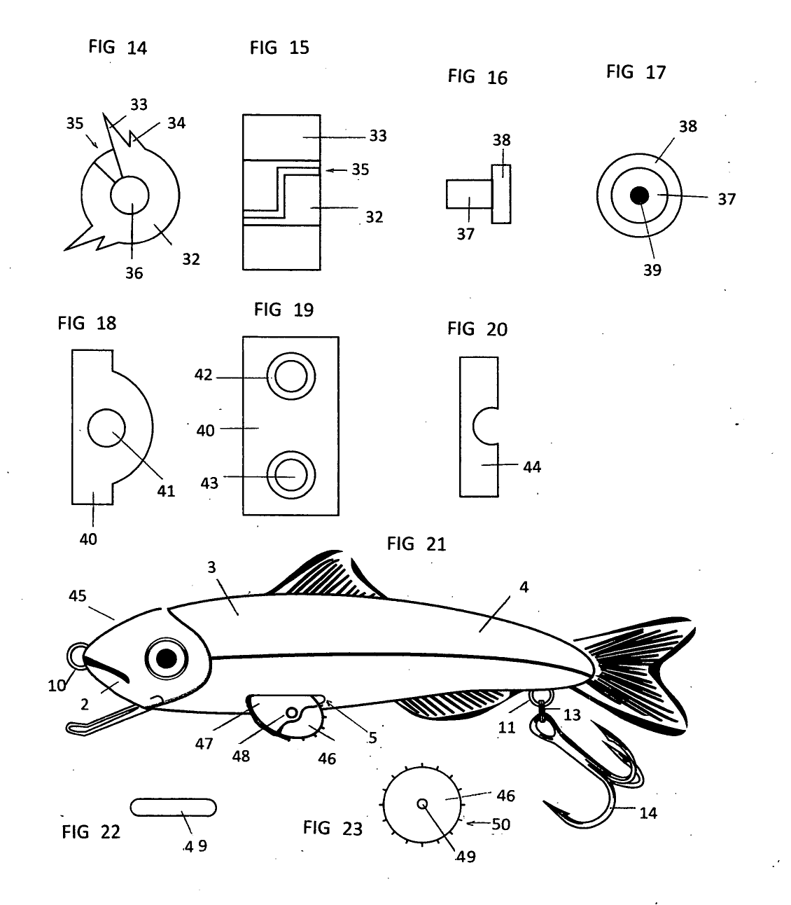

Referring to FIG. 14 shows an end view of a spinner shaft clip. Spinner shaft clip 33 is mounted into a companionate cavity formed in each end of aperture 5 after placing on the ends of spinner shaft 6 by way of clip aperture 36. Channel 35 allows catch tabs 33 to be pinched toward each other thereby moving catch 34(s) toward each other to be passed into their respective receptacles formed at each end of aperture 5 as catch tabs 33 are released the catches 34 engage.

Referring to FIG. 15 shows a side view of a spinner shaft clip. Spinner shaft clip 33 has channel 35 shown in side view which displays the overlapping to contain spinner shaft 6.

Referring to FIG. 16 shows a side view of a spinner shaft retainer barrel. Retainer barrel 37 has lip 38 which serves to limit depth it will insert into an aperture and to pry it back out and is used In conjunction with compressible spacers 19 which allow the assembled spinner shaft 6 with spinners to be passed into the aperture 5 and as the retainer barrel 37 is aligned with an aperture released causing the barrel to capture the shaft in the aperture.

Referring to FIG. 17 shows an end view of a spinner shaft retainer barrel. Retainer barrel 37 has barrel aperture 39 which is slideably passed onto shaft 6.

Referring to FIG. 18 shows an end view of a spinner shaft retainer pillow block. Pillow block 40 is a configuration commonly known in the mechanical arts with block aperture 41 which slideably fits on spinner shaft 6 with the ends of aperture 5 having a companionate profile in which pillow block is seated.

Referring to FIG. 19 shows a side view of a spinner shaft retainer pillow block and half pillow block. Pillow block 40 has screw apertures 43 and counter sink 42 in which screws are passed through and affixes the block holding the spinner shall to the ends of aperture 5.

Referring to FIG. 20 shows an end view of a spinner shaft retainer half pillow block 44. AS previously indicated FIG. 19 also serves as a side view of half pillow block 44.

Referring to FIG. 21, a side view is shown of An artificial bait comprising a lure body 45, at least one interchangeable spinner disk 46, disk mounting fin 47, and disk mounting aperture 48, said body having a forward 2, middle 3, rear section 4, a spinner aperture 5, and said forward section having leader attaching means 10, said body having at least one hook attaching means 11, intermediate hook attaching means 13 and hook 14.

Referring to FIG. 22, shows a side view of a spinner disk shaft 47.

Referring to FIG. 23 shows a top view of a spinner disk 46 which may be solid in color or have a pattern coating and having vanes 50 and spinner disk mounting aperture 49.

I claim:

1. An artificial bait kit comprising:
a lure body, a plurality of interchangeable spinners;
said body having a forward, middle, rear section, left and right side;
said body middle section defining a spinner receiving longitudinal aperture;
a spinner shaft;
spinner shaft mounting means;
said forward and rear section adjacent to said longitudinal aperture defining a shaft mounting means companionate receiving means;
said forward section having leader attaching means;
said body having hook(s) attaching means;
said rear section having a trailing hook attaching means;
each said hook attaching means having an intermediate hook attaching means and hooks;
a fisherman who selects spinners places them on said spinner shaft, engages said shaft mounting means on said spinner shaft, and engages said shaft mounting means into said receiving means;
attaches the leader of a fishing rig to said leader attaching means; and
casts the artificial bait to fish.

2. The artificial bait kit of claim 1 in which the lure body has the general configuration known in the art as a Plug, baitfish, crankbaits, jerkbaits, surface plugs, floating/diving plugs, or poppers or other creatures or shapes known to attract fish and having a coating of color pattern.

3. The artificial bait kit of claim 2 in which interchangeable spinners comprises a plurality and/or mixture of, impellers, beads, drums, cage, bearing beads, spacers, or ribbons.

4. The artificial bait kit of claim 3 in which interchangeable spinners are mounted on a tube which slideable fits on said spinner shaft.

5. The artificial bait kit of claim 4 in which said ribbons further comprise absorbing material which will absorb liquid or paste bait scent.

5. The artificial bait kit of claim 3 in which said cage is loaded with chum, scent bait, inorganic material, or live bait or mixture thereof.

6. The artificial bait kit of claim 3 in which a drum is included as an exchangeable spinner and said drum has a lid through which weights or rattler balls are loaded.

7. The artificial bait kit of claim 3 wherein said longitudinal aperture accommodates a left and right spinner shaft.

8. The artificial bait kit of claim 2 further comprising and emitter system comprising:
a digital controller;
a user alterable program;
a power source;
an energy emitter;
a charging/data transfer port; and
an interconnect system whereby said controller output modulates said emitter;
said emitter system intentional emissions comprising, electromagnetic, sound, light, causing variation of reflection or refraction of coatings; and
said emitter system located within said body or within said drum.

9. The artificial bait kit of claim 2 wherein said longitudinal aperture is in the location of a fin of the represented bait fish further comprising:
a spinner disk;
a spinner disk mount fin;
a spinner disk shaft;
said mount fin comprising a cured channel enclosure describing a disk shaft mounting aperture on its upper and lower surface;
said mount fin attached to said lure proximal to the forward end of said longitudinal aperture; and
said spinner disk installed in said mount fin and affixed by said disk shaft.
